(19) United States
(12) Patent Application Publication
(10) Pub. No.: US 2012/0280991 A1
(43) Pub. Date: Nov. 8, 2012

(54) EMPLOYING MESH FILES TO ANIMATE TRANSITIONS IN CLIENT APPLICATIONS

(75) Inventors: Christopher M. Maloney, San Francisco, CA (US); Ryan C. Hill, Mountain View, CA (US)

(73) Assignee: MICROSOFT CORPORATION, Redmond, WA (US)

(21) Appl. No.: 13/099,952

(22) Filed: May 3, 2011

(51) Int. Cl. G06T 17/00; G06T 15/80; G06T 15/50; G06T 15/00

(52) U.S. Cl. 345/420; 345/419; 345/426

(57) ABSTRACT

A client application requests to animate a transition between document objects. Multi-dimensional modeling data (e.g. as mesh files) matching the transition requests are retrieved. Lighting, shading, and camera effects are applied to the mesh files. Mesh files are parsed to generate a transition file. The transition file is submitted to the client application for rendering. The client application plays the transition file and overlays document object textures over transition object polygons.

### BACKGROUND

Animation usually refers to rapid flow of images faster than human eyes refresh rate giving the illusion of fluid motion. Techniques of animation are centuries old. One of the most prevalent animation techniques is cinematography. In cinematography, film frames are passed thru a light source at a rapid rate and reflected onto a screen. Advances in cinematography have enabled films to be shot by two cameras to record depth. In 3D films, filtering eyewear can create the illusion of depth by allowing each eye to see only alternating frames from one of the cameras.

Animation in computing is accomplished using a variety of techniques. Two and three dimensional techniques are utilized to provide a variety of visual display options to the end user. One approach partitions three dimensional objects to small components and calculates the components coordinate in relation to the environment to be reproduced at render time. A benefit to such partitioning is the ability to apply effects to objects in the environment on the fly. Another benefit is an ability to change aspects of the objects such as color. Objects can also be moved within the environment without having to reshoot an entire sequence of animation. Such calculation based partitioning of objects within an animated environment is seldom used in presentation solutions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to using wire frame models such as mesh files to animate document object transitions. A transition engine may store animations as mesh files. Upon receiving a request for a transition file, the transition engine may parse mesh files corresponding to the request in order to create a transition file. The transition file may be sent to the requesting client application for rendering.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating example components of a system using mesh files to animate transitions in a client application;

FIG. 2 illustrates an example action diagram of employing mesh files to animate transitions;

FIGS. 3A and 3B illustrate example mesh representations of document objects according to some embodiments;

FIG. 4 displays an example transition employing mesh files;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process employing mesh files to animate transitions of document objects according to embodiments.

### DETAILED DESCRIPTION

As briefly described above, mesh files may be employed to animate a transition of a document object in a client application. A transition engine may store animations as a sequence of mesh files. Upon receiving a request for a transition file, the transition engine may parse the mesh files corresponding to the request in order to create a transition file. The transition file may be sent to the requesting client application for rendering to animate the transition of the document object. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer readable memory device. The computer-readable storage medium can for example be implemented via one or more of a volatile computer memory, a non-volatile memory, a hard drive, a flash drive, a floppy disk, or a compact disk, and comparable physical storage media.

Throughout this specification, the term “platform” may be a combination of software and hardware components for employing mesh files to animate transitions in client applications. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

To model three dimensional or physical object used in computer graphics a wire frame model may be used for visual presentation. Such a model may be created by specifying each edge of the object where two mathematically continuous smooth surfaces meet or by connecting an object's constituent vertices using straight lines or curves. The object may then be projected onto the computer screen by drawing lines at the location of each edge.

One of the formats used for wire frame modeling is a mesh model. In a mesh model, a vertex is a position along with other information such as color, normal vector and texture coordinates. An edge is a connection between two vertices. A face is a closed set of edges, in which a triangle face has three edges, and a quad face has four edges. A polygon is a set of faces. In systems covering objects with multi-sided faces, polygons and faces are equivalent. However, polygons may also be represented as multiple faces. A polygonal mesh may be considered an unstructured grid, or undirected graph, with addition properties of geometry, shape and topology.

Objects created with polygon meshes may store different types of elements. The elements may include vertices, edges, faces, polygons and surfaces. Mesh models may also define other useful data. For example, groups may be defined with separate elements of the mesh for determining separate sub-objects for skeletal animation or separate actors for non-skeletal animation. Using a wire frame model allows visualization of the underlying design structure of a three dimensional model. Thus, traditional two dimensional views and drawings may be created by appropriate rotation of the object and selection of hidden line removal via cutting planes. While references are made to “mesh files” throughout the Specification and Claims, embodiments are not limited to a particular mesh format. Any multi-dimensional modeling formats may be used applying the principles discussed herein.

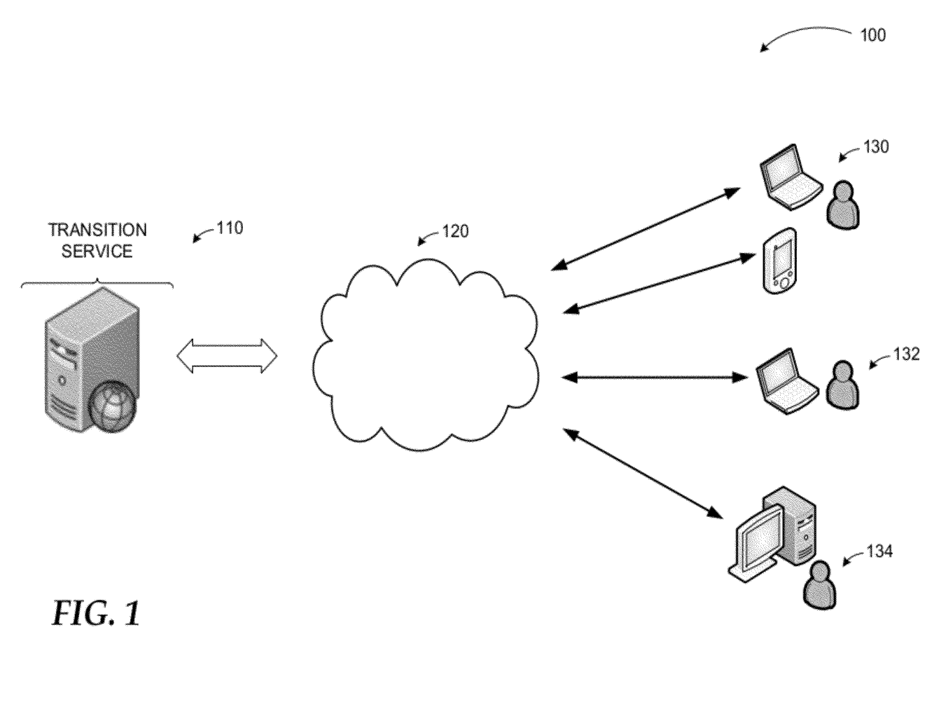

FIG. 1 is a diagram illustrating example components of a system using mesh files to animate transitions in a client application. In diagram 100, the server 110 may host a service that provides online applications such as presentation applications enabling animated transitions for document objects. An example document object transition may be a slide change in a presentation application. The service may interpret animated mesh data used to create the concepts and convert that into a generalized transition onto which any image (or a slide) may be attached. This allows a designer to precisely specify the movement of the objects in the scene during the course of a transition, while reducing the amount of time and complexity that may be needed in producing a new transition. The network 120 may be a local network or may be an external entity such as an Internet based infrastructure. It may provide wired or wireless connectivity. Clients 130, 132, 134, and the service may connect to each other through unsecured or secured connectivity. An example of a secured connectivity may be a Virtual Private Network (VPN) established among the clients and the event coordination service with the use of encrypted communications.

The server 110 may construct a transition file corresponding to a request from a client application. The transition file may contain parsed mesh files. Meshed files are representative constructs of animations as discussed above. Mesh files contain partitioned components of an animation. A mesh file may partition a component as polygons. Polygons may be in a variety of shapes including but not exclusive to triangle and rectangular (or square) polygons. Polygon count of a component may be increased to boost resolution. Alternatively polygon count of a component may be decreased to limit resolution and save memory, storage, and processing capacity.

In an alternative embodiment, the server 110 may provide a service using mesh files containing vertices to partition components of an animation. Vertices are edge points of polygons. Vertices may be represented by x and y coordinates for two dimensional polygons. Alternatively, vertices may be represented by x, y, and z coordinates for three dimensional polygons. The mesh file may contain the animation component partitioned as polygons using vertices. The service on server 110 may search for matching mesh files for descriptions of animations in the client application request. Upon finding the matching mesh files, the service may parse the mesh files to generate a transition file to be rendered by the client application to create an animated object transition. Alternatively, the service may not be executed in a separate server. The service may be executed in the same device running the client application. Additionally, embodiments are not limited to client/server and peer-to-peer architectures. Employing mesh files to animate transitions in client applications may be accomplished using other architectures.

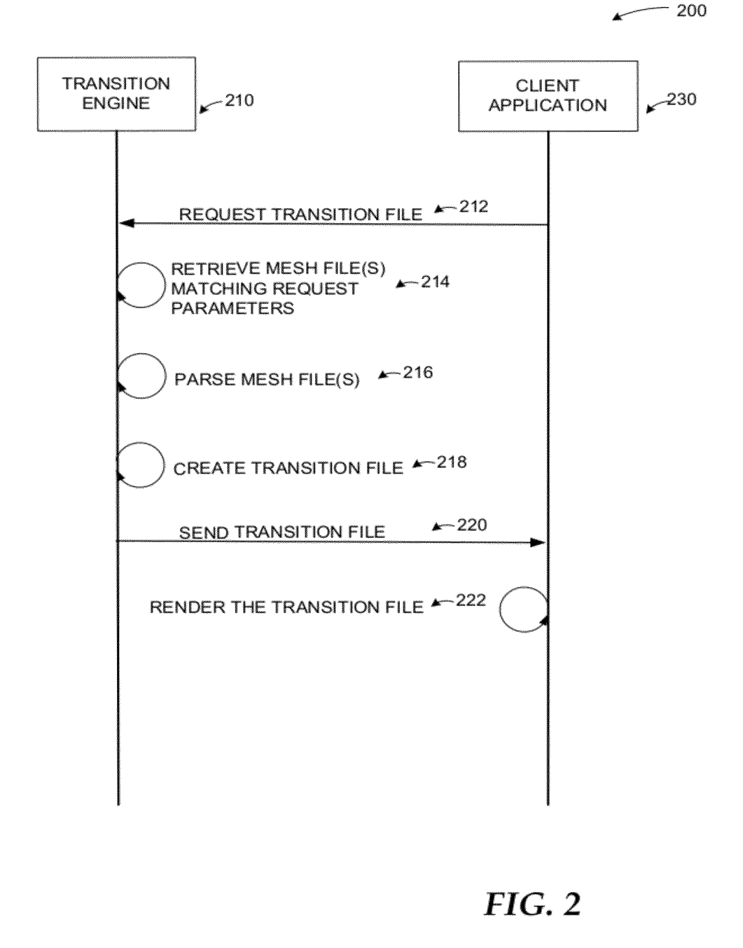

FIG. 2 illustrates an example action diagram of employing mesh files to animate transitions. A system according to an embodiment may serve transition files containing mesh data representing animations to enable a client application to animate its transitions. In diagram 200, a transition engine 210 may receive a request for a transition file 212 from client application 230. The request for a transition file may be a simple communication containing a description of a document object and a motion to animate the document object. An example scenario may be a request to animate a transition of a slide (displayed in a presentation application) containing a triangle shape. The client application may submit a request containing a description of the slide and a motion to get to the next slide.

In subsequent action 214, the transition engine 210 may retrieve mesh file(s) matching request parameters. The transition engine may search locally stored mesh files to locate animations matching the request parameters. Alternatively, the transition engine may search external mesh file storage solutions containing animations. The complexity of the search result depends on the request parameters. If the request for a transition contains multiple document object components (i.e.: figures in a slide), the transition engine may retrieve a mesh file for each component. Alternatively, a mesh file may describe only the document object (i.e.: a slide). In such a scenario, the mesh file search may return two mesh files. An example may be one mesh file for the starting slide and one mesh file for the end slide.

Upon retrieving mesh file(s) matching the request, the transition engine may parse the mesh file(s) 216. Parsing the mesh file(s) may involve analyzing the matching mesh file(s) and combining the mesh file(s) with any motion description within the request. In an example scenario, the transition engine may combine mesh files matching each component in a slide and a motion description to create the transition file 218. Alternatively, the transition may be a simple combination of two mesh files representing a start and end slide and a motion. An example may be a motion replacing the polygons in the start slide mesh file with the polygons in the end slide mesh file.

In another embodiment, the mesh files may be associated with a motion component. The transition engine may take advantage of the motion component of the mesh files by retrieving a mesh file sequence matching the motion described in the requested transition. Next, the transition engine may send the transition file 220 to the client application. The client application may render the transition file 222 by overlaying texture from the document object (i.e.: a slide) on polygons of the mesh data in the transition file and playing the transition.

The document may be a presentation document, a word processing document, a charting file, etc. The document object may be a slide, an image, a graph, etc. The client application may be a presentation, a word processing, and a charting application displaying the document. Alternatively, the client application may be a browser or a communication user interface (UI) application displaying changes to document based objects.

The described mesh file based transition animations are for illustration purposes. Other multi-dimensional modeling based animations may be used to transition a document object to another. Furthermore, parsing mesh files to produce a transition file (e.g., combining mesh files representing a start and end document object) may be performed by an application executed on the computing device itself, instead of a communicatively coupled service. For example, a special purpose application or a module of the device's operating system may parse and create a transition file as described above and provide the transition file to animate changes to the document object.

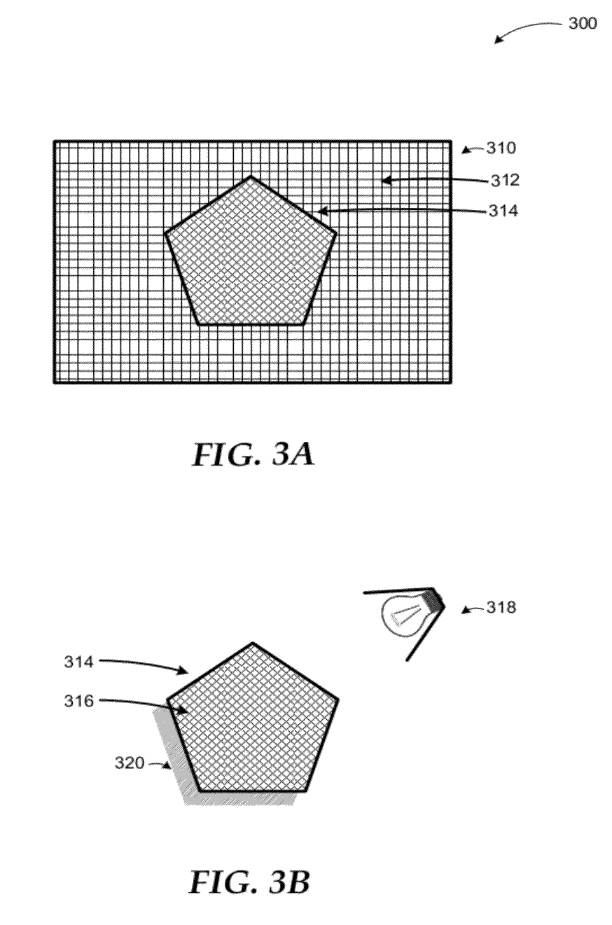

FIGS. 3A and 3B illustrate example mesh representations of document objects according to some embodiments. Diagram 300 illustrates mesh file representation of document objects to be transitioned. Document object 310 may be a slide being displayed in a presentation application. The document object may be represented as a mesh file accessible by a transition engine. The mesh file may be partitioned into polygons with rectangle shapes 312. Alternatively the mesh file may be partitioned into polygons having other shapes such as triangle, etc. The mesh file may also contain a representation of a pentagon shaped component 314. The mesh file may partition the pentagon shaped component with differently shaped polygons to distinguish it from the document object 310.

In FIG. 3B, each mesh file may correspond to a component of the document object. In an example scenario, the pentagon shaped component 314 may be represented by its own mesh file. The mesh file may be partitioned by diamond shaped polygons 316. The polygon shape is not limited to diamond shapes but may be any shape to enable a calculation based description of a component. In addition, the mesh file may include a lighting effect 318 with a direction component. The direction component and the intensity of the light may enable calculation of a shading effect 320 for the pentagon shaped component. The shading effect may be stored in the mesh file. Alternatively the shading effect may be calculated on the fly by the client application during display of the pentagon shaped component.

The scenarios discussed above are provided as example embodiments. Other scenarios may be used to employ mesh files to animate transitions in client applications using the principles discussed herein.

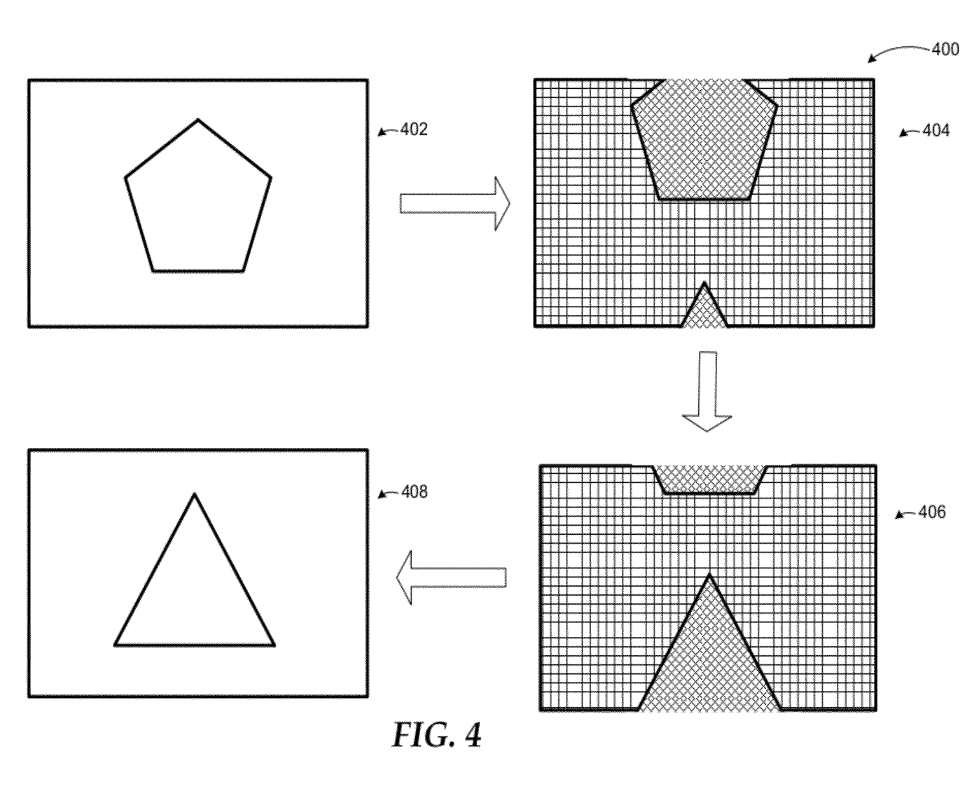

FIG. 4 displays an example transition employing mesh files. Diagram 400 shows example stages of a transition from a start document object 402 to an end document object 408. An example document object may be a slide displayed in a presentation application as described above. The transition engine may analyze the request for a transition file from the client and retrieve two mesh files matching the start and end document objects. The transition engine may interpolate a start frame, multiple intermediate frames 404, 406, and an end frame based on the request attributes. The intermediate frames may simply move component of the start frame away from view while bringing the component of the end frame into view. The transition engine may store the generated frames as mesh files and parse the mesh files to create the transition file. The transition file may also contain a duration element to slow or speed the play of the frames.

In an embodiment, the client application may render the transition file by applying textures to the mesh data. The client application may apply textures from the start document object (i.e.: a start image) to the first frame described in the mesh data of the transition file. The client application may also apply textures from the end document object (i.e.: an end image) to the end frame described in the mesh data of the transition file.

In another embodiment, the transition file may describe a directional motion along x, y, and/or z axis. In yet another embodiment, the transition engine may apply a camera lens effect to the mesh files. The camera lens effect may put a subset of the mesh files into focus (i.e.: a component of a slide) while putting non-subset mesh files out of the focus (i.e.: the remaining part of the slide).

In other embodiments, the client application may apply textures to the mesh data by overlaying pixels of a document object image (i.e.: a slide image) over polygons of the mesh data. Each polygon may get a corresponding matching size portion of the document object image. Additionally, number of polygons (i.e.: triangle shaped polygons) may be varied to adjust the complexity of the transition. Transition complexity may be represented by a complexity value. Furthermore, mesh files may contain vertices and polygons for two and three dimensional components in the document object.

The systems and implementations of employing mesh files to animate transitions in client applications discussed above are for illustration purposes and do not constitute a limitation on embodiments. Using mesh files to animate transitions may be implemented by an application layer and an application user interface. Creating transition files may be accomplished by a variety of operations including retrieving mesh files matching to request parameters. Using mesh files to animate transitions may be implemented employing other modules, processes, and configurations using the principles discussed herein.

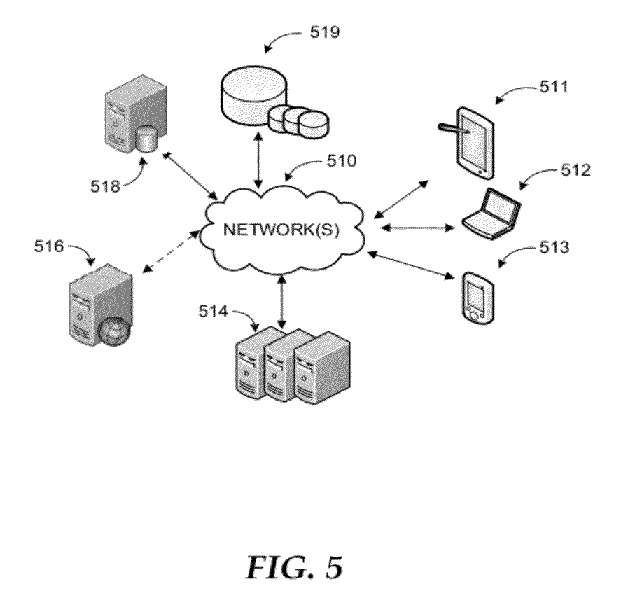

FIG. 5 is an example networked environment, where embodiments may be implemented. Enabling animations in a computing device may be initiated via software executed over one or more servers 514 or a single server (e.g. web server) 516 such as a hosted service. The platform may communicate with client applications on individual computing devices such as a smart phone 513, a laptop computer 512, or tablet computer 511 (‘client devices’) through network(s) 510.

As discussed above, a service may employ mesh files to animate transitions of document objects. A transition may be rendered by playing the transition file on the client devices 511-513. Lighting, shading, and camera effects may be applied to the mesh files.

Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to animate transitions using mesh files. Furthermore, the networked environments discussed in FIG. 5 are for illustration purposes only. Embodiments are not limited to the example applications, modules, or processes.

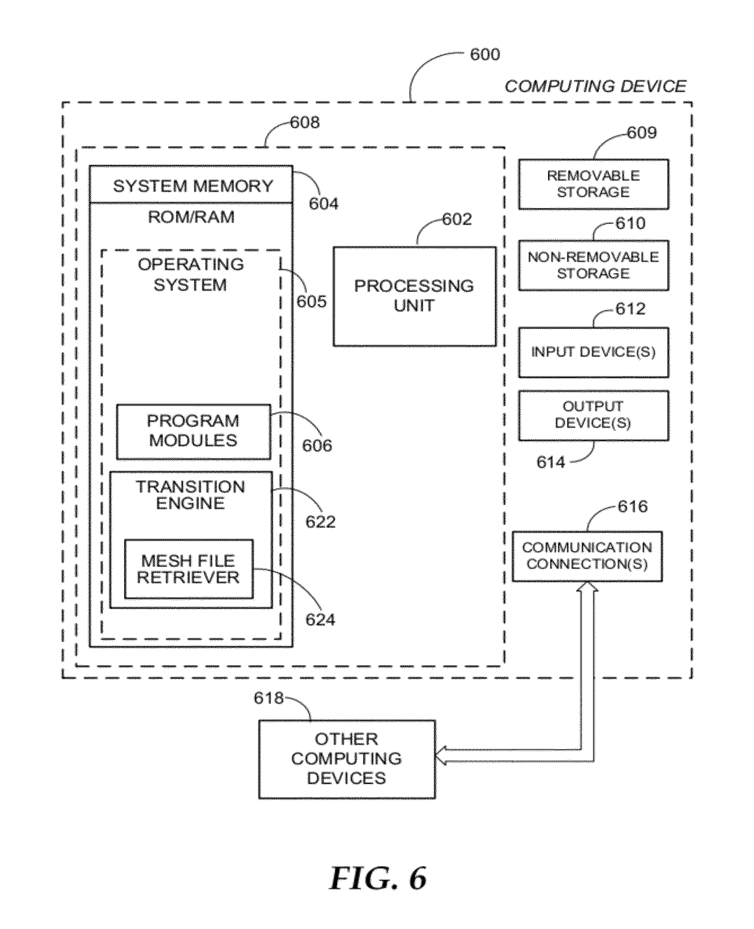

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, transition engine 622, and mesh file retriever module 624.

Transition engine 622 may be part of a service employing mesh files to animate transitions in a client application. Mesh file retriever module 624 may search and retrieve mesh files matching request parameters. Matching mesh files may be parsed to create a transition file to be rendered by the client application. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

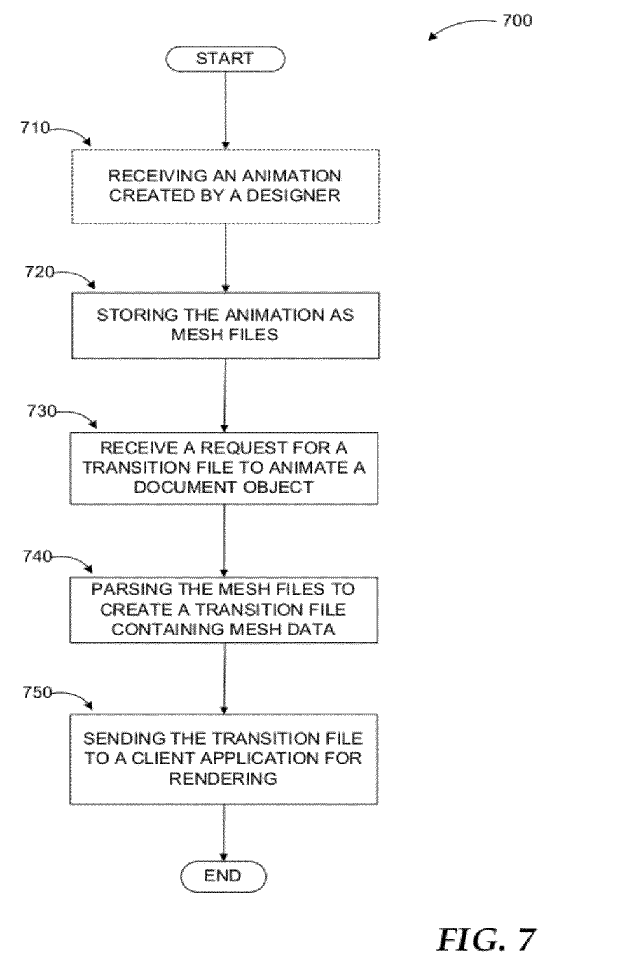

FIG. 7 illustrates a logic flow diagram for a process employing mesh files to animate transitions of document objects according to embodiments. Process 700 may be implemented by a presentation, word processing, or similar application on any computing device.

Process 700 may begin with receiving an animation created by a designer at operation 710 followed by storing the animation as mesh files at operation 720. The transition engine may receive a request for a transition file to animate a document object (i.e.: a slide) at operation 730. Matching mesh files may be parsed to create a transition file as discussed above at operation 740. Then, the transition file may be sent to the client application for rendering at operation 750 (e.g., play the transition file, overlay textures on polygons, etc).

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Employing mesh files to animate transitions on client applications according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for animating transitions employing multi-dimensional modeling data, the method comprising:
receiving animation data;
storing the animation data in a multi-dimensional modeling format;
receiving a request for a transition file to animate a document object;
parsing the animation data in the multi-dimensional modeling format to create the transition file for the document object; and
sending the transition file to a client application for rendering.

2. The method of claim 1, wherein the animation data in the multi-dimensional modeling format is stored as one or more mesh files.

3. The method of claim 1, wherein each mesh file corresponds to a component to be animated in the document object.

4. The method of claim 1, wherein the client application renders the transition file by applying textures to the animation data.

5. The method of claim 4, wherein the textures are from a start image at a first frame of the transition file and an end image at an end frame of the transition file.

6. The method of claim 1, further comprising:
interpolating a start frame and an end frame from the animation data in the multi-dimensional modeling format employing one or more intermediate frames.

7. The method of claim 1, further comprising:
applying a shading effect to the animation data.

8. The method of claim 1, wherein the transition file describes a directional movement along at least one of x, y, and z axis.

9. The method of claim 1, wherein the animation data in the multi-dimensional modeling format includes at least one from a set of: polygons, vertices of the polygons, and coordinates of the vertices.

10. The method of claim 9, wherein each polygon has one of a square shape and a triangle shape.

11. A computing device capable of animating document presentation transitions employing multi-dimensional modeling data, the computing device comprising:
a memory;
a processor coupled to the memory, the processor executing an application in conjunction with instructions stored in the memory, wherein the application is configured to:
receive animation data;
store the animation data in a multi-dimensional modeling format;
receive a request for a transition file to animate a document object;
analyze the request to determine components to be animated in the document object;
search and retrieve one or more files of the animation data in a multi-dimensional modeling format matching the components to be animated;
parse the retrieved files to create the transition file based on the animation data; and
send the transition file to a client application for rendering by applying textures to the animation data.

12. The computing device of claim 11, wherein the client application is one from a set of: a presentation application, a word processing application, a browser application, a charting application, and a communication application with graphic user interface.

13. The computing device of claim 11, further configured to:
apply a lighting effect with a direction component to the animation data; and
produce a shading effect based on the direction component of the lighting effect.

14. The computing device of claim 11, further configured to:
apply a camera lens effect to the animation data.

15. The computing device of claim 14, wherein the camera lens effect places into focus a subset of the animation data while placing remaining animation data out of focus.

16. The computing device of claim 11, wherein the client application applies textures to the animation data by overlaying pixels of an image of each component over polygons of the animation data.

17. The computing device of claim 16, wherein the transition file contains a start frame, a plurality of intermediate frames, and an end frame interpolated from the animation data and a duration value specified in the request.

18. A computer-readable memory device with instructions stored thereon for animating transitions employing multi-dimensional modeling data, the instructions comprising:
receiving animation data;
storing the animation data as one or more mesh files;
receiving a request for a transition file to animate a document object;
retrieving one or more mesh files associated with components of the document object to be animated;
applying a lighting effect with a direction component to the retrieved mesh files; and
producing a shading effect based on the direction component of the lighting effect
parsing the retrieved mesh files to create the transition file based on the animation data; and
sending the transition file to a client application for rendering by applying textures to the animation data.

19. The computer-readable memory device of claim 18, wherein the mesh files include vertices and polygons for two and three dimensional components of the document object.

20. The computer-readable memory device of claim 18, wherein the mesh files include triangle polygons of dynamically varying numbers adjusted corresponding to a complexity value of the transition.
